(19) United States
(12) Patent Application Publication
(10) Pub. No.: US 2026/0212851 A1
(43) Pub. Date: Jul. 23, 2026

(54) MASSIVE MULTI-PLAYER INTERACTIVE ENVIRONMENT

(71) Applicant: SPHERE ENTERTAINMENT GROUP, LLC, New York, NY (US)

(72) Inventors: Benjamin POYNTER, Los Angeles, CA (US); Adam Todd BERNSTEIN, Port Washington, NY (US)

(73) Assignee: SPHERE ENTERTAINMENT GROUP, LLC, New York, NY (US)

(21) Appl. No.: 19/034,095

(22) Filed: Jan. 22, 2025

(51) Int. Cl. G10H 1/36; G10L 25/84

(52) U.S. Cl. CPC G10H 1/361; G10L 25/84; G10H 2210/091; G10H 2220/145

(57) ABSTRACT

Systems, methods, and apparatuses can provide one or more massive multi-player interactive activities that incorporate music, such as karaoke, lip sync battles, dance parties or dance battles, sing-along movies, talent shows, sound and music games, and/or group or choir singing, among others. These systems, methods, and apparatuses can provide one or more musical tracks and/or one or more musical lyrics that are associated with these interactive activities that an audience is expected to perform as part of the one or more massive multi-player interactive activities. These systems, methods, and apparatuses can distinguish the vocal performance of their audience members from the overall vocal performance of the audience in the massive multi-player karaoke. These systems, methods, and apparatuses can evaluate the vocal performance of their audience members to score the performance of their audience members in performing the one or more massive multi-player interactive activities.

### BACKGROUND

Karaoke entertainment, often referred to simply as karaoke, has become a popular social activity that encourages fun, engagement, and friendly competition. Karaoke is a form of interactive activity where participants sing along to a song with the aid of on screen musical lyrics that are synchronized in time with one or more musical tracks. It is commonly performed at small-scale events or gatherings such as bars, lounges, private karaoke rooms, restaurants, cafes, and nightlife venues. These events can involve a single participant or a small group of participants, where they take turns singing along to their favorite songs, for example, in their respective languages. Karaoke is often accompanied by music systems that provide high-quality instrumental tracks and the original lyrics of the song, enhancing the overall experience. Over the years, karaoke has evolved, with many home karaoke systems allowing people to enjoy the activity in the comfort of their own homes, further broadening its appeal.

### BRIEF DESCRIPTION OF THE DRAWINGS

The present disclosure is described with reference to the accompanying drawings. In the drawings, reference numbers indicate identical or functionally similar elements. Additionally, the left most digit(s) of a reference number identifies the drawing in which the reference number first appears. In the accompanying drawings:

FIG. 1 illustrates a pictorial representation of an exemplary massive multi-player interactive environment according to some exemplary embodiments of the present disclosure;

FIG. 2 graphically illustrates an exemplary mobile computing device that can be implemented within the exemplary massive multi-player interactive environment according to some exemplary embodiments of the present disclosure;

FIG. 3 illustrates an exemplary operational control flow for implementing exemplary massive multi-player karaoke within the exemplary massive multi-player interactive environment according to some exemplary embodiments of the present disclosure;

FIG. 4 illustrates another exemplary operational control flow for implementing exemplary massive multi-player karaoke within the exemplary massive multi-player interactive environment according to some exemplary embodiments of the present disclosure; and

FIG. 5 illustrates a simplified block diagram of an exemplary computer system that can be implemented within the exemplary playback environment according to some exemplary embodiments of the present disclosure.

The present disclosure will now be described with reference to the accompanying drawings.

### DETAILED DESCRIPTION

The following disclosure provides many different embodiments, or examples, for implementing different features of the provided subject matter. Specific examples of components and arrangements are described herein to simplify the present disclosure. These are, of course, merely examples and are not intended to be limiting. Aspects of the present disclosure are best understood from the following detailed description when read with the accompanying figures. The present disclosure may repeat reference numerals and/or letters in the various examples. This repetition does not in itself dictate a relationship between the various embodiments and/or configurations discussed. It is noted that, in accordance with the standard practice in the industry, features are not drawn to scale. In fact, the dimensions of the features may be arbitrarily increased or reduced for clarity of discussion. The following disclosure may include the terms “about” or “substantially” to indicate the value of a given quantity can vary based on a particular technology. Based on the technology, the term “about” or “substantially” can indicate a value of a given quantity that varies within, for example, 1-15% of the value (e.g., ±1%, ±2%, ±5%, ±10%, or ±15% of the value).

### Overview

Systems, methods, and apparatuses can provide one or more massive multi-player interactive activities that incorporate music, such as karaoke, lip sync battles, dance parties or dance battles, sing-along movies, talent shows, sound and music games, and/or group or choir singing, among others. These systems, methods, and apparatuses can provide one or more musical tracks and/or one or more musical lyrics that are associated with these interactive activities that an audience is expected to perform as part of the one or more massive multi-player interactive activities. These systems, methods, and apparatuses can distinguish the vocal performance of their audience members from the overall vocal performance of the audience in the massive multi-player karaoke. These systems, methods, and apparatuses can evaluate the vocal performance of their audience members to score the performance of their audience members in performing the one or more massive multi-player interactive activities.

### Exemplary Interactive Environment

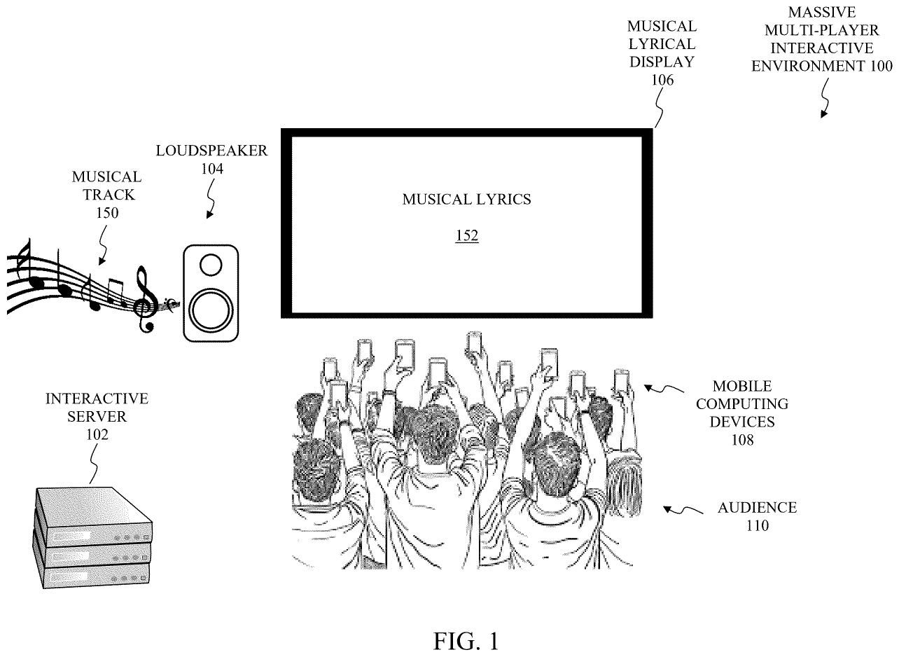

FIG. 1 illustrates a pictorial representation of an exemplary massive multi-player interactive environment according to some exemplary embodiments of the present disclosure. In the exemplary embodiment illustrated in FIG. 1, a massive multi-player interactive environment 100 can offer engaging and enjoyable interactive experiences centered around music, performance, and/or group participation, among others. In some embodiments, the massive multi-player interactive environment 100 can provide one or more massive multi-player interactive activities that incorporate songs, such as karaoke, lip sync battles, dance parties or dance battles, sing-along movies, talent shows, sound and music games, and/or group or choir singing, among others. In these embodiments, these one or more massive multi-player interactive activities can be incorporated within large, expansive environments, such as a music venue, for example, a music theater, a music club, and/or a concert hall, a sporting venue, for example, an arena, a convention center, and/or a stadium, and/or any other suitable venue that will be apparent to those skilled in the relevant art(s) without departing the spirit and scope of the present disclosure to provide one or more massive interactive activities. Alternatively, or in addition to, these massive interactive activities can involve a large group of participants, for example, hundreds, thousands, tens of thousands, and even more. In some embodiments, the massive multi-player interactive environment 100 can provide one or more musical tracks and/or one or more musical lyrics, among others, for an audience within the massive multi-player interactive environment 100 to perform. In these embodiments, the one or more musical tracks can represent one or more instrumental tracks of a song that includes one or more musical elements of the song, such as melodies, harmonies, and/or rhythms to provide some examples, among others. Alternatively, or in addition to, the one or more instrumental tracks often do not include the lead vocals that are associated with the song. In these embodiments, the one or more musical lyrics can represent the words or text that are associated with the one or more instrumental tracks of the song. For example, the one or more musical lyrics can accompany the melodies, the harmonies, and/or the rhythms, among others, of the song. In the exemplary embodiment illustrated in FIG. 1, the massive multi-player interactive environment 100 can include one or more interactive servers 102, one or more loudspeakers 104, one or more musical lyrical displays 106, and one or more mobile computing devices 108 that are associated with an audience 110 within the massive multi-player interactive environment 100.

The one or more interactive servers 102 represent one or more computing systems, an exemplary embodiment of which is to be described herein, that manage the one or more massive multi-player interactive activities within the massive multi-player interactive environment 100 that incorporate the music, such as karaoke, lip sync battles, dance parties or dance battles, sing-along movies, talent shows, sound and music games, and/or group or choir singing, among others. As illustrated in FIG. 1, the one or more interactive servers 102 can identify one or more musical tracks 150 and/or one or more musical lyrics 152 that are associated with these interactive activities. In some embodiments, the one or more interactive servers 102 can identify the one or more musical tracks 150 and/or musical lyrics 152 that are associated with a song that the audience 110 is expected to perform as part of these interactive activities. In these embodiments, the one or more musical tracks 150 can represent one or more instrumental tracks of the song that include the musical elements of the song, such as melodies, harmonies, and/or rhythms to provide some examples, among others. Alternatively, or in addition to, the one or more instrumental tracks often do not include one or more musical lyric tracks that are associated with the one or more musical lyrics 152, for example, the lead vocals, that are associated with the song. In some embodiments, the one or more musical lyrics 152 can represent the words or text that are associated with the one or more instrumental tracks of the song. In these embodiments, the one or more musical lyrics 152 can beneficially guide the audience 110 in performing the one or more massive multi-player interactive activities.

In some embodiments, the song can be a previously recorded song, often referred to as a pre-recorded song, that has been, for example, recorded and produced in a musical studio. In these embodiments, the one or more interactive servers 102 can access the pre-recorded song from among a library of pre-recorded songs that are accessible by the one or more interactive servers 102, for example, hosted on one or more remote servers managed by one or more cloud storage services. In these embodiments, the one or more musical tracks 150 can represent the one or more instrumental tracks of the pre-recorded song and the one or more musical lyrics 152 can represent the words or text that are associated with these instrumental tracks. Alternatively, or in addition to, the song can be a live song that is being performed live within the massive multi-player interactive environment 100. In some embodiments, the live song can be performed in real-time by participants, artists, musicians, or the like within the massive multi-player interactive environment 100. In these embodiments, the one or more musical tracks 150 can represent the one or more instrumental tracks of the live song that is being performed within the massive multi-player interactive environment 100 and the one or more musical lyrics 152 can represent the words or text that are associated with these instrumental tracks.

After identifying the one or more musical tracks 150 and/or musical lyrics 152, the one or more interactive servers 102 can provide the one or more musical tracks 150 to the one or more loudspeakers 104 and/or the one or more musical lyrics 152 to the one or more musical lyrical displays 106. In some embodiments, the audience 110 can hear the one or more musical tracks 150 and/or see the one or more musical lyrics 152 while engaging in the one or more massive multi-player interactive activities. In these embodiments, the audience 110 can listen to the one or more instrumental tracks of the song while following the words or text that are associated with these instrumental tracks enabling them to participate in the one or more massive multi-player interactive activities.

As illustrated in FIG. 1, the one or more loudspeakers 104 can playback the one or more musical tracks 150 to the audience 110. In the exemplary embodiment illustrated in FIG. 1, the one or more loudspeakers 104 can reproduce melodies, harmonies, rhythms, or the like received from the one or more interactive servers 102 to provide the one or more musical tracks 150 to the audience 110 as described herein. In some embodiments, the one or more loudspeakers 104 can include one or more super tweeters, one or more tweeters, one or more mid-range speakers, one or more woofers, one or more subwoofers, one or more full-range speakers, and/or any other suitable device that is capable of reproducing the audible frequency range, or a portion thereof, that will be apparent to those skilled in the relevant art(s) without departing from the spirit and scope of the present disclosure. In some embodiments, multiple loudspeakers from among the one or more loudspeakers 104 can be configured and arranged to form a loudspeaker module. In these embodiments, the loudspeaker module is capable of provide wave field synthesis (WFS) and/or beamforming capabilities. In these embodiments, multiple loudspeaker modules can be configured and arranged to form a loudspeaker array to emit precisely controlled sound waves in the massive multi-player interactive environment 100 to create highly localized and customizable audio zones within the massive multi-player interactive environment 100.

As illustrated in FIG. 1, the one or more musical lyrical displays 106 can present the one or more musical lyrics 152 to the audience 110. In the exemplary embodiment illustrated in FIG. 1, the one or more musical lyrical displays 106 can show words, text, images, videos, animations, and the like received from the one or more interactive servers 102 to present the musical lyrics 152 to the audience 110 as described herein. In some embodiments, the one or more musical lyrical displays 106 can be high-definition (HD) or ultra-high-definition (UHD), offering enhanced resolution for sharper and more detailed visual content. In these embodiments, the one or more musical lyrical displays 106 can be implemented using various technologies, such as liquid crystal displays (LCDs), light providing diodes (LEDs), organic LEDs (OLEDs), quantum dot LEDs (QLEDs), plasma displays, active-matrix OLEDs, curved displays, and/or touchscreens, among others. In some embodiments, the one or more musical lyrical displays 106 can include a series of rows and a series of columns of picture elements, also referred to as pixels, in three-dimensions that form a three-dimensional media plane to project the one or more musical lyrics 152 onto the three-dimensional media plane. In these embodiments, the three-dimensional media plane can extend around the interior of the massive multi-player interactive environment 100 to create an immersive visual experience. In the exemplary embodiment illustrated in FIG. 1, the one or more musical lyrical displays 106 often work in tandem with the one or more loudspeakers 104 to create a cohesive sensory experience for the audience 110 during in the one or more massive multi-player interactive activities.

As illustrated in FIG. 1, the one or more mobile computing devices 108 can monitor the audience 110 during in the one or more massive multi-player interactive activities. The one or more mobile computing devices 108 can include one or more consumer electronics devices, cellular phones, smartphones, feature phones, tablet computers, wearable computing devices, laptop computers, and/or the like. In the exemplary embodiment illustrated in FIG. 1, the one or more mobile computing devices 108 can track participation of their corresponding members of the audience 110. In some embodiments, the one or more mobile computing devices 108 can distinguish the performance of their corresponding members from the overall performance of the audience 110. In these embodiments, the one or more mobile computing devices 108 can identify one or more specific actions performed by their corresponding members during in the one or more massive multi-player interactive activities. In these embodiments, the one or more mobile computing devices 108 can isolate the one or more specific actions performed by their corresponding members from the overall actions performed by the audience 110 during in the one or more massive multi-player interactive activities.

In some embodiments, the one or more mobile computing devices 108 can assess performance of the one or more massive multi-player interactive activities by leveraging advanced auditory and visual analysis to ensure fair and engaging scoring. In the exemplary embodiment illustrated in FIG. 1, the one or more mobile computing devices 108 can evaluate the one or more specific actions performed by their corresponding members during in the one or more massive multi-player interactive activities. In some embodiments, the one or more mobile computing devices 108 can evaluate the one or more specific actions performed by their corresponding members in terms of auditory factors and/or visual factors, for example, accuracy, timing and synchronization, rhythm, and/or engagement and performance, among others. In these embodiments, the one or more mobile computing devices 108 can compare the one or more specific actions performed by their corresponding members during the one or more massive multi-player interactive activities with the one or more musical tracks 150 and/or musical lyrics 152 to score the one or more specific actions performed by their corresponding members. In some embodiments, the one or more mobile computing devices 108 can score the accuracy, the timing and the synchronization, the rhythm, and/or the engagement and performance, among others, of their corresponding members individually and can thereafter combine these scores using a weighted average, or other formulas, to produce overall scores of their corresponding members. In these embodiments, the one or more mobile computing devices 108 can provide these overall scores to their corresponding members in real-time, or near-real time to advantageously encourage their corresponding members to adjust their performance in real time. Alternatively, or in addition to, the one or more mobile computing devices 108 can provide the overall scores of their corresponding members to the one or more interactive servers 102. In some embodiments, the one or more interactive servers 102 can calculate an overall audience score for the audience 110, or any subset of the audience 110. In these embodiments, the one or more interactive servers 102 can combine the overall scores of their corresponding members using a weighted average, or other formulas, to produce the overall audience score for the audience 110, or any subset of the audience 110. In some embodiments, the one or more interactive servers 102 can provide the overall audience score for the audience 110, or any subset of the audience 110, to the one or more mobile computing devices 108. In these embodiments, the one or more mobile computing devices 108 can provide the overall audience score for the audience 110, or any subset of the audience 110, to their corresponding members in real-time, or near-real time to advantageously encourage their corresponding members to adjust their performance in real time.

In some embodiments, the one or more musical tracks 150 can arrive at their corresponding members at different instances in time. For example, those corresponding members that are seated further away from the one or more loudspeakers 104 can hear the one or more musical tracks 150 at later instances in time than those corresponding members that are seated closer to the one or more loudspeakers 104. As a result, those corresponding members further away from the one or more loudspeakers 104 often perform their specific actions later in time which can effectively diminish their accuracy, timing and synchronization, rhythm, and/or engagement and performance, among others. In these embodiments, the one or more mobile computing devices 108 can effectively compensate for these different instances in time such that the accuracy, timing and synchronization, rhythm, and/or engagement and performance, among others, of their corresponding members can be characterized as no longer being dependent upon their distance from the one or more loudspeakers 104. This effectively decouples the one or more specific actions performed by their corresponding members from their distances from the one or more loudspeakers 104 allowing the accuracy and/or the synchronization of the one or more specific actions performed by their corresponding members to be related to the performance, for example, timing, of the specific actions themselves. In some embodiments, the one or more mobile computing devices 108 can time-shift the one or more specific actions performed by their corresponding members based upon flight times of the one or more musical tracks 150 from the one or more loudspeakers 104 to their corresponding members to compensate for the different instances in time that their corresponding members heard the one or more musical tracks 150. This compensation is further described in U.S. patent application Ser. No. 17/237,808, filed Apr. 22, 2021, which is incorporated herein by reference in its entirety.

### Exemplary Massive Multi-Player Karaoke Entertainment Within the Interactive Experience Environment With Music

Karaoke entertainment, often referred to simply as karaoke, is one of the one or more massive multi-player interactive activities where the audience 110 performs the song as described herein. It is popular worldwide and provides a fun, creative way to enjoy music, regardless of singing ability. In karaoke, the one or more musical tracks 150 and/or musical lyrics 152 as described herein are provided with some of the original vocals of the song, for example, the lead vocals, being removed, or reduced, allowing the audience 110 to perform these parts themselves. In some embodiments, the one or more loudspeakers 104 can playback the one or more musical tracks 150 to the audience 110 and the one or more musical lyrical displays 106 can present the one or more musical lyrics 152 to the audience 110. In these embodiments, the one or more musical lyrics 152 can accompanied by visual cues or highlighted text to guide the audience 110 to stay synchronized with the one or more musical tracks 150. Karaoke is traditionally performed at small-scale karaoke events or gatherings, for example, bars and lounges, private karaoke rooms, restaurants and cafes, clubs and nightlife venues, or the like involving a single participant, or small group of participants. The exemplary massive multi-player interactive environments described herein can extend karaoke, as well as any of the one or more massive multi-player interactive activities described herein, to larger, more expansive events, involving a large group of participants, for example, hundreds, thousands, tens of thousands, and even more participants, also referred to as massive multi-player karaoke.

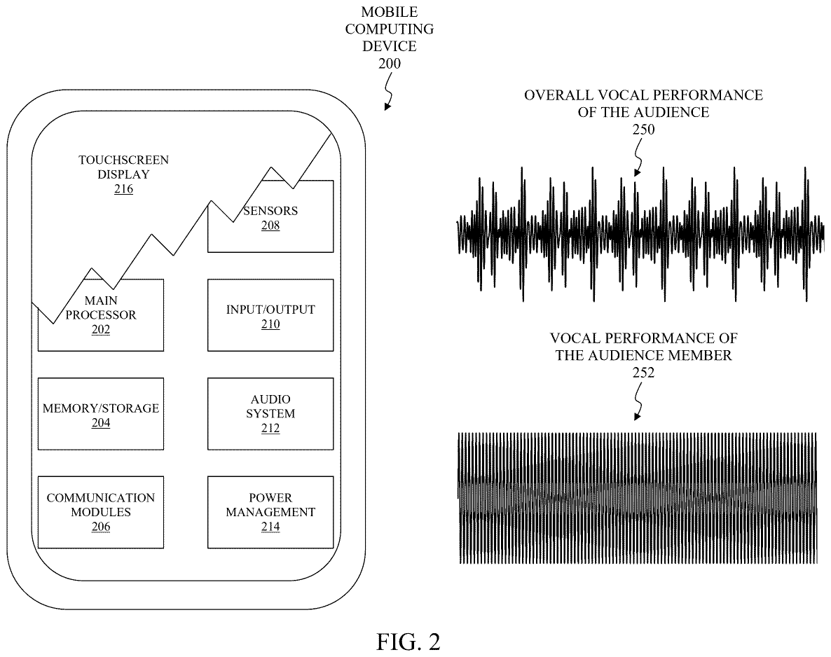

FIG. 2 graphically illustrates an exemplary mobile computing device that can be implemented within the exemplary massive multi-player interactive environment according to some exemplary embodiments of the present disclosure. In the exemplary embodiment illustrated in FIG. 2, a mobile communication device 200 can monitor a member of an audience as the audience member participates in massive multi-player karaoke along with other members of the audience. In some embodiments, the mobile communication device 200 can distinguish the vocal performance of the audience member from the overall vocal performance of the audience in the massive multi-player karaoke. After isolating the vocal performance of the audience member, the mobile communication device 200 can assess the vocal performance of the audience member as the audience member participates in the massive multi-player karaoke in these embodiments. As illustrated in FIG. 2, the mobile communication device 200 can include a main processor 202, a memory/storage 204, communication modules 206, sensors 208, input/output 210, an audio system 212, and/or power management 214.

The main processor 202 represents a primary, or main, processor of the mobile communication device 200 to process, calculate, and/or control instructions from a computer program, such as arithmetic, logic, controlling, and input/output (I/O) instructions to provide some examples. Although not illustrated in FIG. 2, the main processor 202 can include one or more central processing units (CPUs) to execute instructions, perform calculations, and mange flow of data throughout the mobile communication device 200. In some embodiments, the one or more CPUs can include one or more control units (CUs) to manage and/or to coordinate the execution of the instructions, one or more arithmetic logic unit (ALUs) to execute arithmetic and/or logic operations on binary integer numbers from instructions provided by the one or more CUs, a register to store data, often temporary, for processing, a cache memory to store frequently accessed data and instructions, an instruction decoder to interpret instructions for the one or more ALUs, and/or one or more floating point units (FPUs) to execute arithmetic and logic operations on floating point numbers from the instructions provided by the one or more CUs to provide some examples. In the exemplary embodiment illustrated in FIG. 2, the main processor 202 can execute an application program, a software application, an application, or the like, referred to as a massive multi-player karaoke application for simplicity, to implement the massive multi-player karaoke as described herein. Although those skilled in the relevant art(s) will that the massive multi-player karaoke application may be described herein as performing certain actions, it should be appreciated that such descriptions are merely for convenience and that such actions in fact result from the main processor 202 executing the massive multi-player karaoke application.

In the exemplary embodiment illustrated in FIG. 2, the massive multi-player karaoke application can functionally cooperate with the main processor 202 to implement the massive multi-player karaoke as described herein. In some embodiments, the main processor 202 can playback the one or more musical tracks 150 and/or present the one or more musical lyrics 152 to the audience member allowing them to participate in the massive multiplayer karaoke. In some embodiments, the main processor 202 can distinguish a vocal performance of the audience member 252 from an overall vocal performance of the audience 250 as the audience participates the massive multi-player karaoke. In the exemplary embodiment as illustrated in FIG. 2, the main processor 202 can access the overall vocal performance of the audience 250 that is associated with the collective singing effort and/or vocal expression of the audience as they participate in the massive multi-player karaoke. As illustrated in FIG. 2, the overall vocal performance of the audience 250 can include soundwaves generated by the audience during the massive multi-player karaoke. In some embodiments, the vertical height of the overall vocal performance of the audience 250 indicates the loudness or softness of these soundwaves, the horizontal distance between the peaks of the overall vocal performance of the audience 250 indicates the pitch of these soundwaves. In some embodiments, the main processor 202 can retrieve the overall vocal performance of the audience 250 from the memory/storage 204 and/or in real-time, or near real-time from, for example, the audio system 212.

After accessing the overall vocal performance of the audience 250, the main processor 202 can isolate the vocal performance of the audience member 252 from the overall vocal performance of the audience 250. In some embodiments, the main processor 202 can identify the vocal performance of the audience member 252 from the overall vocal performance of the audience 250. In these embodiments, the main processor 202 can implement Machine Learning (ML), Artificial Intelligence (AI), Neural Networks, Deep Learning (DL), Reinforcement Learning (RL), and/or Speech Recognition, among others, to identify the vocal performance of the audience member 252 from the overall vocal performance of the audience 250. In some embodiments, the main processor 202 can analyze the overall vocal performance of the audience 250 in a frequency domain for a frequency pattern that is associated with the audience member or in a time domain for a time pattern that is associated with the audience member to identify the vocal performance of the audience member 252 from the overall vocal performance of the audience 250. In these embodiments, the main processor 202 can utilize training data, such as isolated words, continuous speech, and/or multilingual speech, among others, to advantageously learn the frequency patterns and/or the time patterns that are associated with the audience member. In these embodiments, the main processor 202 can identify the frequency patterns and/or the time patterns that are associated with the audience member from the overall vocal performance of the audience 250 using one or more source separation techniques, for example, spectral masking or clustering. Alternatively, or in addition to, the main processor 202 can identify the frequency patterns and/or the time patterns that are associated with the audience member from the overall vocal performance of the audience 250 through feature analysis, for example, detecting characteristics such as pitch, timbre, and/or harmonic structure, among others, of the vocal performance of the member. After identifying the vocal performance of the member, the main processor 202 can isolate the vocal performance of the audience member 252 from the overall vocal performance of the audience 250.

In some embodiments, the main processor 202 can assess the vocal performance of the audience member 252 by leveraging advanced auditory and visual analysis to ensure fair and engaging scoring. In the exemplary embodiment illustrated in FIG. 1, the main processor 202 can evaluate the vocal performance of the audience member 252 to score, for example, numerically quantify, the audience member's participation in the massive multi-player karaoke. In some embodiments, the main processor 202 can evaluate the vocal performance of the audience member 252 performed by the audience member in terms of auditory factors and/or visual factors, for example, accuracy, timing and synchronization, rhythm, and/or engagement and vocal performance, among others. In these embodiments, the main processor 202 can compare the vocal performance of the audience member 252 with the one or more musical tracks 150 and/or musical lyrics 152 to score the vocal performance of the audience member 252. In some embodiments, the main processor 202 can perform this comparison in the time domain and/or the frequency domain. For example, the main processor 202 can examine the pitch accuracy in the frequency domain by comparing the frequencies of the audience member' voice with the target pitch from the one or more musical tracks 150. In this example, the main processor 202 can decrease the score of the audience member for deviations from the target pitch and/or increase the score of the audience member for accurate pitch results. As another example, the main processor 202 measure timing accuracy of the audience member in the time domain, for example, whether the audience member' voice is synchronized with the one or more musical tracks 150 and/or musical lyrics 152. In this other example, the main processor 202 can decrease the score of the audience member for being too late or too early. In some embodiments, the main processor 202 can score the accuracy, the timing and the synchronization, the rhythm, and/or the engagement and performance, among others, of the audience member individually and can thereafter combine these scores using a weighted average, or other formulas, to produce a composite score of the audience member. In these embodiments, the main processor 202 can provide one or more of these scores to the audience member in real-time, or near-real time to advantageously encourage the audience member to adjust their vocal performance in real time.

The memory/storage 204 ensure smooth operation of applications and provide space for storing the operating system, user files, apps, and/or media, among others. In some embodiments, the memory/storage 204 can store the massive multi-player karaoke application described herein for execution by the main processor 202. Alternatively, or in addition to, the memory/storage 204 can store the overall vocal performance of the audience 250 and/or the vocal performance of the audience member 252 described herein for retrieval by the main processor 202. In some embodiments, the can include a short-term storage area, often referred to as volatile memory, to temporarily store instructions and/or data that are needed by the main processor 202 to execute instructions. The memory/storage 204 can be characterized as providing the main processor 202 with high-speed access to frequently used data and/or instructions. In some embodiments, the memory/storage 204 can include, but is not limited to, random-access memory (RAM) Dynamic RAM, Static RAM, and/or Double Data Rate (DDR) RAM; cache memory, such as L1 Cache memory, L2 Cache memory, and/or L3 Cache memory, to provide some examples, and/or read only memory (ROM), among others. The memory/storage 204 represents a long-term storage area, often referred to as non-volatile memory, to permanently, or semi-permanently, store programs, files, and/or data. In some embodiments, these programs, files, and/or data can include, or be related to, the operating system, software applications, documents and files, media content, archived data, installers, system files and configurations, and/or software updates, among others. In some embodiments, the memory/storage 204 can include hard disk drives, solid-state drives (SSDs), hybrid drives (SSHD), optical drives, floppy disk drives along with associated removable media, CD-ROM drives, optical drives, flash memories, and/or removable media cartridges.

The communication modules 206 enable the mobile communication device 200 to communicate with, for example, the one or more interactive servers 102 described herein, using wireless connectivity standards, such as 3G, 4G, 4G long term evolution (LTE), and/or 5G to provide some examples, a version of an Institute of Electrical and Electronics Engineers (I.E.E.E.) 802.11 communication standard, for example, 802.11a, 802.11b/g/n, 802.11h, and/or 802.11ac which are collectively referred to as Wi-Fi, an I.E.E.E. 802.16 communication standard, also referred to as WiMax, a version of a Bluetooth communication standard, and/or or any other wireless communication standard or protocol that will be apparent to those skilled in the relevant art(s) without departing from the spirit and scope of the present disclosure to allow for data transmission across different ranges and network types. In these embodiments, the communication modules 206 can facilitate seamless connectivity for applications such as internet browsing, voice calls, and/or data transfer, among others. In the exemplary embodiment illustrated in FIG. 2, the communication modules 206 are well known by those skilled in the relevant art(s) and will not be discussed in further detail.

The sensors 208 can gather data from the environment or user interaction. The sensors 208 can include accelerometers, proximity sensors, ambient light sensors, barometers, magnetometers, heart rate monitors, and/or biometric sensors such as fingerprint scanners or facial recognition systems, among others. In the exemplary embodiment illustrated in FIG. 2, the sensors 208 are well known by those skilled in the relevant art(s) and will not be discussed in further detail.

The input/output 210 includes interfaces for user interaction and external communication. In some embodiments, the input/output 210 can include a touchscreen, physical buttons or haptic feedback systems, microphones, speakers and/or cameras, among others. In these embodiments, the input/output 210 can capture the overall vocal performance of the audience 250 described herein as the audience participates in the massive multi-player karaoke.

The audio system 212 can manage sound processing to ensure high-quality audio input and output within the mobile communication device 200. In some embodiments, the audio system 212 can include Digital-to-Analog (DAC) and Analog-to-Digital (ADC) converters to manage sound quality, ensuring high-fidelity playback and accurate capture of sound through the microphones. In these embodiments, the audio system 212 can utilize advanced audio processing algorithms to improve sound quality, noise cancellation, and speaker optimization, supporting media playback, calls, voice commands, and sound-based applications. In some embodiments, the audio system 212 can further include an audio codec, amplifier circuits, and sound enhancements, for example, surround sound or equalization, among others. In the exemplary embodiment illustrated in FIG. 2, the main processor 202 can delegate, or offload, some or all of the routines, instructions, operations, tasks, processes, actions, or the like to the audio system 212 as described herein to optimize efficiency, particularly for audio-related tasks. In some embodiments, the main processor 202 can delegate, or offload, any of the routines, instructions, operations, tasks, processes, actions, or the like needed to distinguish the vocal performance of the audience member 252 from the overall vocal performance of the audience 250 in the massive multi-player karaoke onto the audio system 212. In these embodiments, the main processor 202 can offload some, or all, of the routines, instructions, operations, tasks, processes, actions, or the like needed to identify the vocal performance of the audience member 252 as described herein onto the audio system 212. Alternatively, or in addition to, the main processor 202 can offload some, or all, of the routines, instructions, operations, tasks, processes, actions, or the like needed to isolate the vocal performance of the audience member 252 from the overall vocal performance of the audience 250 as described herein onto the audio system 212.

The power management 214 optimizes energy consumption and battery life of the mobile communication device 200. The power management 214 monitors charge levels, health, and temperature, managing charging cycles to maximize longevity. Power distribution regulators, such as voltage regulators and buck/boost converters, supply power to different components at appropriate voltages while minimizing waste heat. The power management 214 dynamically adjusts the power usage of the mobile communication device 200, for example, implementing techniques like processor throttling and screen dimming to extend battery life under heavy use or idle conditions. Additionally, the power management 214 can employ wireless charging, fast charging technologies, and energy-efficient sleep modes, among others.

### Exemplary Operational Control Flow for the Exemplary Interactive Environment

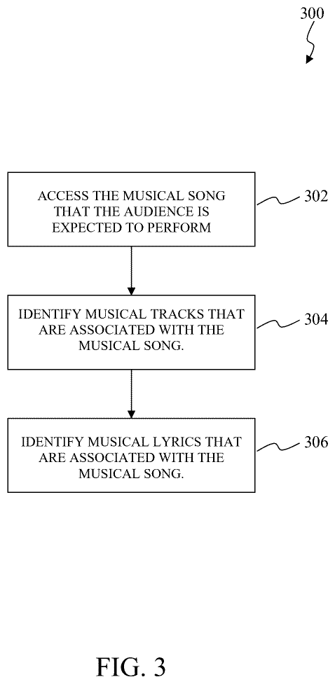

FIG. 3 illustrates an exemplary operational control flow for implementing exemplary massive multi-player karaoke within the exemplary massive multi-player interactive environment according to some exemplary embodiments of the present disclosure. The following discussion is to describe an exemplary operational control flow 300 for implementing the exemplary massive multi-player karaoke within the exemplary massive multi-player interactive environment. The present disclosure is not limited to these exemplary operational control flows. Rather, it will be apparent to ordinary persons skilled in the relevant art(s) that other operational control flows are within the scope and spirit of the present disclosure. In some embodiments, the operational control flow 300 can be performed by one or more computing systems, such as the one or more interactive servers 102 described herein. Generally, these computing systems, an exemplary embodiment of which is described herein, can identify one or more musical tracks, such as one or more of the one or more musical tracks 150, and/or one or more musical lyrics, such as one or more of the one or more musical lyrics 152, that are associated with a song that an audience is expected to perform as part of the exemplary massive multi-player karaoke.

At step 302, the operational control flow 300 accesses the song that the audience is expected to perform as part of the exemplary massive multi-player karaoke. In some embodiments, the song can be a previously recorded song, often referred to as a pre-recorded song, that has been, for example, recorded and produced in a musical studio as described herein. Alternatively, or in addition to, the song can be a live song that is being performed within the exemplary massive multi-player interactive environment as described herein.

At step 304, the operational control flow 300 identifies the one or more musical tracks that are associated with the song. In some embodiments, the one or more musical tracks can represent one or more instrumental tracks of the song that include the musical elements of the song, such as melodies, harmonies, and/or rhythms to provide some examples, among others. In these embodiments, the operational control flow 300 can search for the one or more musical tracks from official or fan-created instrumental tracks, which can be hosted by music streaming platforms, producers, or music libraries. Alternatively, or in addition to, the operational control flow 300 can utilize audio processing software tools to isolate different instrumental tracks from the song. Alternatively, or in addition to, the operational control flow 300 can reference sheet music that provides a detailed breakdowns the one or more musical tracks that are associated with the song. In some embodiments, the operational control flow 300 can provide the one or more musical tracks to one or more loudspeakers for delivery to the audience. In these embodiments, the audience can listen to the one or more musical tracks of the song as they are being played back while engaging in the exemplary massive multi-player karaoke.

At step 306, the operational control flow 300 identifies the one or more musical lyrics that are associated with the song. In some embodiments, the one or more musical lyrics can represent the words or text that are associated with the one or more instrumental tracks of the song. In these embodiments, the one or more musical lyrics can beneficially guide the audience in performing the exemplary massive multi-player karaoke. In some embodiments, the operational control flow 300 can access the one or more musical lyrics from various musical platforms, for example, a verified database, the publisher, and/or the official artist's website, among others. In some embodiments, the operational control flow 300 can provide the one or more musical lyrics to one or more musical lyrical displays for delivery to the audience. In these embodiments, the audience can follow the one or more musical lyrical displays as they are being displayed while engaging in the exemplary massive multi-player karaoke.

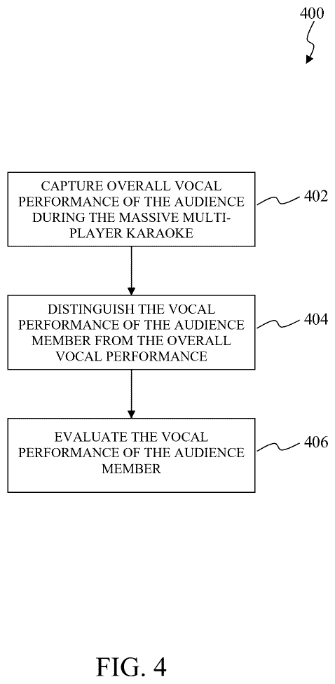

FIG. 4 illustrates another exemplary operational control flow for implementing exemplary massive multi-player karaoke within the exemplary massive multi-player interactive environment according to some exemplary embodiments of the present disclosure. The following discussion is to describe an exemplary operational control flow 400 for implementing exemplary massive multi-player karaoke within the exemplary massive multi-player interactive environment. The present disclosure is not limited to these exemplary operational control flows. Rather, it will be apparent to ordinary persons skilled in the relevant art(s) that other operational control flows are within the scope and spirit of the present disclosure. In some embodiments, the operational control flow 400 can be performed by a mobile computing devices such as one of the one or more mobile computing devices 108 described herein. Generally, this mobile computing device, an exemplary embodiment of which is described herein, can distinguish the vocal performance of the audience member from the overall vocal performance of the audience in the massive multi-player karaoke. In some embodiments, this mobile computing device can evaluate the vocal performance of the audience member to score the performance of the audience member in performing the exemplary massive multi-player karaoke.

At step 402, the operational control flow 400 accesses the overall vocal performance of the audience, such as the overall vocal performance of the audience 250, as the audience participates in the exemplary massive multi-player karaoke. In some embodiments, the overall vocal performance of the audience represents the collective singing effort and/or vocal expression of the audience as they participate in the exemplary massive multi-player karaoke. In these embodiments, the overall vocal performance of the audience can range from harmonious to chaotic, reflecting the diverse abilities of the audience and their level of synchronization. For example, emotional expression can play a key role in the overall vocal performance of the audience, as the audience can convey excitement, humor, nostalgia, or dramatic flair through their voices. In these embodiments, the overall vocal performance of the audience can include improvisation and playfulness, with ad-libbing, cheering, and/or humorous interpretations, among others of the song. In some embodiments, the massive multi-player karaoke can be typically supportive and inclusive, encouraging participation and fostering a communal sense of fun, regardless of the skill level of the audience. In some embodiments, the operational control flow 400 can capture the overall vocal performance of the audience using for example, one or more microphones.

At step 504, the operational control flow 400 can distinguish the vocal performance of the audience member, such as the vocal performance of the audience member 252, from the overall vocal performance of the audience. In some embodiments, the operational control flow 400 can identify the vocal performance of the audience member from the overall vocal performance of the audience as described herein. In these embodiments, the operational control flow 400 can implement Machine Learning (ML), Artificial Intelligence (AI), Neural Networks, Deep Learning (DL), Reinforcement Learning (RL), and/or Speech Recognition, among others, to identify the vocal performance of the audience member from the overall vocal performance of the audience as described herein. After identifying the vocal performance of the member, the operational control flow 400 can isolate the vocal performance of the audience member from the overall vocal performance of the audience as described herein.

At step 506, the operational control flow 400 evaluates the vocal performance of the audience member 252 to score, for example, numerically quantify, the audience member's participation in the massive multi-player karaoke. In some embodiments, the operational control flow 400 can evaluate the vocal performance of the audience member 252 performed by the audience member in terms of auditory factors and/or visual factors, for example, accuracy, timing and synchronization, rhythm, and/or engagement and vocal performance, among others as described herein. In some embodiments, the main processor 202 can score the accuracy, the timing and the synchronization, the rhythm, and/or the engagement and performance, among others, of the audience member individually and can thereafter combine these scores using a weighted average, or other formulas, to produce a composite score of the audience member.

### Exemplary Computer System That can be Implemented Within the Exemplary Interactive Environment

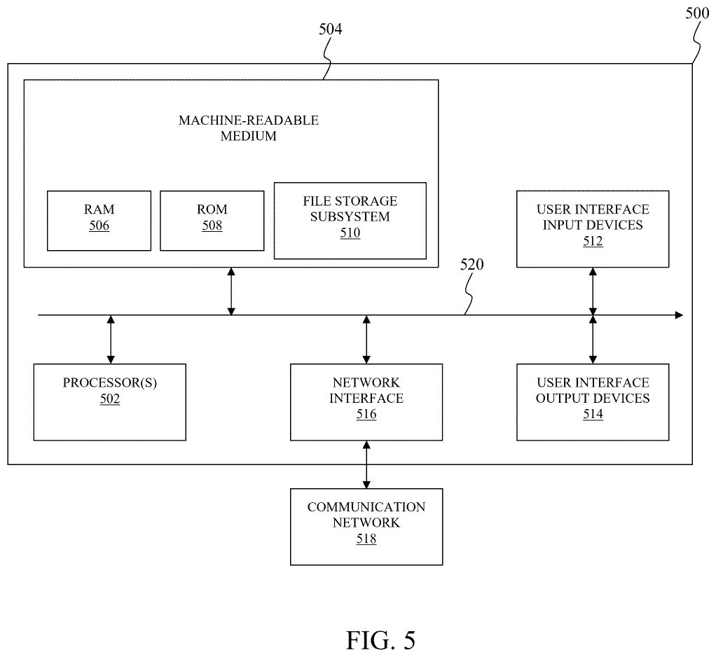

FIG. 5 illustrates a simplified block diagram of an exemplary computer system that can be implemented within the exemplary playback environment according to some exemplary embodiments of the present disclosure. The discussion of FIG. 5 to follow is to describe a computer system 500 that can be used to implement one or more of the one or more interactive servers 102 as described above.

In the exemplary embodiment illustrated in FIG. 5, the computer system 500 includes one or more processors 502. In some embodiments, the one or more processors 502 can include, or can be, any of a microprocessor, graphics processing unit, or digital signal processor, and their electronic processing equivalents, such as an Application Specific Integrated Circuit (“ASIC”) or Field Programmable Gate Array (“FPGA”). As used herein, the term “processor” signifies a tangible data and information processing device that physically transforms data and information, typically using a sequence transformation (also referred to as “operations”). Data and information can be physically represented by an electrical, magnetic, optical or acoustical signal that is capable of being stored, accessed, transferred, combined, compared, or otherwise manipulated by the processor. The term “processor” can signify a singular processor and multi-core systems or multi-processor arrays, including graphic processing units, digital signal processors, digital processors or combinations of these elements. The processor can be electronic, for example, comprising digital logic circuitry (for example, binary logic), or analog (for example, an operational amplifier). The processor may also operate to support vocal performance of the relevant operations in a “cloud computing” environment or as a “software as a service” (SaaS). For example, at least some of the operations may be performed by a group of processors available at a distributed or remote system, these processors accessible via a communications network (e.g., the Internet) and via one or more software interfaces (e.g., an application program interface (API).) In some embodiments, the computer system 500 can include an operating system, such as Microsoft's Windows, Sun Microsystems's Solaris, Apple Computer's MacOs, Linux or UNIX. In some embodiments, the computer system 500 can also include a Basic Input/Output System (BIOS) and processor firmware. The operating system, BIOS and firmware are used by the one or more processors 502 to control subsystems and interfaces coupled to the one or more processors 502. In some embodiments, the one or more processors 502 can include the Pentium and Itanium from Intel, the Opteron and Athlon from Advanced Micro Devices, and the ARM processor from ARM Holdings.

As illustrated in FIG. 5, the computer system 500 can include a machine-readable medium 504. In some embodiments, the machine-readable medium 504 can further include a main random-access memory (“RAM”) 506, a read only memory (“ROM”) 508, and/or a file storage subsystem 510. The RAM 530 can store instructions and data during program execution and the ROM 532 can store fixed instructions. The file storage subsystem 510 provides persistent storage for program and data files, and may include a hard disk drive, a floppy disk drive and associated removable media, a CD-ROM drive, an optical drive, a flash memory, or removable media cartridges.

The computer system 500 can further include user interface input devices 512 and user interface output devices 514. The user interface input devices 512 can include an alphanumeric keyboard, a keypad, pointing devices such as a mouse, trackball, touchpad, stylus, or graphics tablet, a scanner, a touchscreen incorporated into the display, audio input devices such as voice recognition systems or microphones, eye-gaze recognition, brainwave pattern recognition, and other types of input devices to provide some examples. The user interface input devices 512 can be connected by wire or wirelessly to the computer system 500. Generally, the user interface input devices 512 are intended to include all possible types of devices and ways to input information into the computer system 500. The user interface input devices 512 typically allow a user to identify objects, icons, text and the like that appear on some types of user interface output devices, for example, a display subsystem. The user interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other device for creating a visible image such as a virtual reality system. The display subsystem may also provide non-visual display such as via audio output or tactile output (e.g., vibrations) devices. Generally, the user interface output devices 520 are intended to include all possible types of devices and ways to output information from the computer system 500.

The computer system 500 can further include a network interface 516 to provide an interface to outside networks, including an interface to a communication network 518, and is coupled via the communication network 518 to corresponding interface devices in other computer systems or machines. The communication network 518 may comprise many interconnected computer systems, machines and communication links. These communication links may be wired links, optical links, wireless links, or any other devices for communication of information. The communication network 518 can be any suitable computer network, for example a wide area network such as the Internet, and/or a local area network such as Ethernet. The communication network 518 can be wired and/or wireless, and the communication network can use encryption and decryption methods, such as is available with a virtual private network. The communication network uses one or more communications interfaces, which can receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. One or more communications protocols can be used, such as HTTP, TCP/IP, RTP/RTSP, IPX and/or UDP.

As illustrated in FIG. 5, the one or more processors 502, the machine-readable medium 504, the user interface input devices 512, the user interface output devices 514, and/or the network interface 516 can be communicatively coupled to one another using a bus subsystem 520. Although the bus subsystem 520 is shown schematically as a single bus, alternative embodiments of the bus subsystem may use multiple buses. For example, RAM-based main memory can communicate directly with file storage systems using Direct Memory Access (“DMA”) systems.

### Conclusion

The Detailed Description referred to accompanying figures to illustrate exemplary embodiments consistent with the disclosure. References in the disclosure to “an exemplary embodiment” indicates that the exemplary embodiment described can include a particular feature, structure, or characteristic, but every exemplary embodiment may not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

The Detailed Description is not meant to be limiting. Rather, the scope of the disclosure is defined only in accordance with the following claims and their equivalents. It is to be appreciated that the Detailed Description section, and not the Abstract section, is intended to be used to interpret the claims. The Abstract section can set forth one or more, but not all exemplary embodiments, of the disclosure, and thus, are not intended to limit the disclosure and the following claims and their equivalents in any way.

The exemplary embodiments described within the disclosure have been provided for illustrative purposes and are not intended to be limiting. Other exemplary embodiments are possible, and modifications can be made to the exemplary embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Embodiments of the disclosure can be implemented in hardware, firmware, software application, or any combination thereof. Embodiments of the disclosure can also be implemented as instructions stored on a machine-readable medium, which can be read and executed by processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing devices, processors, controllers, or other devices executing the firmware, software application, routines, instructions, etc.

The Detailed Description of the exemplary embodiments fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A method for implementing massive multi-player karaoke within a venue, the method comprising:
accessing, by a mobile computing device, an overall vocal performance of an audience as the audience performs a song as part of the massive multi-player karaoke;
identifying, by the mobile computing device, a vocal performance of an audience member that is associated the mobile computing device from the overall vocal performance of the audience;
isolating, by the mobile computing device, the vocal performance of the audience member from the overall vocal performance of the audience; and
evaluating, by the mobile computing device, the vocal performance of the audience member to score a participation of the audience member in the massive multi-player karaoke.

2. The method of claim 1, wherein the accessing comprises capturing the overall vocal performance of the audience as the audience performs the song as part of the massive multi-player karaoke.

3. The method of claim 1, wherein the identifying comprises analyzing the overall vocal performance of the audience in a frequency domain for a frequency pattern that is associated with the audience member or in a time domain for a time pattern that is associated with the audience member to identify the vocal performance of the audience member from the overall vocal performance of the audience.

4. The method of claim 3, wherein the analyzing comprises identifying the frequency pattern or the time pattern from the overall vocal performance of the audience through feature analysis.

5. The method of claim 4, wherein the feature analysis comprises detecting pitch, timbre, or harmonic structure of the audience member from the overall vocal performance of the audience to identify the frequency pattern or the time pattern.

6. The method of claim 4, wherein the analyzing comprises using Machine Learning (ML), Artificial Intelligence (AI), Neural Networks, Deep Learning (DL), Reinforcement Learning (RL), or Speech Recognition to perform the feature analysis to identify the frequency pattern or the time pattern.

7. The method of claim 5, wherein the analyzing comprises training the ML, the AI, the Neural Networks, the DL, the RL, or the Speech Recognition in accordance with training data that is associated with the member of the audience to learn the frequency pattern or the time pattern.

8. A method for implementing massive multi-player karaoke within a venue, the mobile computing device comprising:
a memory that stores an overall vocal performance of an audience as the audience performs a song as part of the massive multi-player karaoke; and
a processor configured to execute instructions that are stored in the memory, the instructions, when executed by the processor, configuring the processor to:
identify a vocal performance of an audience member that is associated the mobile computing device from the overall vocal performance of the audience,
isolate the vocal performance of the audience member from the overall vocal performance of the audience, and
evaluate the vocal performance of the audience member to score a participation of the audience member in the massive multi-player karaoke.

9. The mobile computing device of claim 8, wherein the instructions, when executed by the processor, configure the processor to capture the overall vocal performance of the audience as the audience performs the song as part of the massive multi-player karaoke.

10. The mobile computing device of claim 8, wherein the instructions, when executed by the processor, configure the processor to analyze the overall vocal performance of the audience in a frequency domain for a frequency pattern that is associated with the audience member or in a time domain for a time pattern that is associated with the audience member to identify the vocal performance of the audience member from the overall vocal performance of the audience.

11. The mobile computing device of claim 10, wherein the instructions, when executed by the processor, configure the processor to identify the frequency pattern or the time pattern from the overall vocal performance of the audience through feature analysis.

12. The mobile computing device of claim 11, wherein the feature analysis comprises detecting pitch, timbre, or harmonic structure of the audience member from the overall vocal performance of the audience to identify the frequency pattern or the time pattern.

13. The mobile computing device of claim 11, wherein the instructions, when executed by the processor, configure the processor to use Machine Learning (ML), Artificial Intelligence (AI), Neural Networks, Deep Learning (DL), Reinforcement Learning (RL), or Speech Recognition to perform the feature analysis to identify the frequency pattern or the time pattern.

14. The mobile computing device of claim 13, wherein the instructions, when executed by the processor, configure the processor to train the ML, the AI, the Neural Networks, the DL, the RL, or the Speech Recognition in accordance with training data that is associated with the member of the audience to learn the frequency pattern or the time pattern.

15. A venue for implementing massive multi-player karaoke within a venue, the venue comprising:
an interactive server configured to identify a musical track and a musical lyric that are associated with a song to be performed by an audience as part of the massive multi-player karaoke; and
a plurality of mobile computing devices, at least one mobile computing device from among the plurality of mobile computing devices being configured to:
access an overall vocal performance of the audience as the audience performs the song as part of the massive multi-player karaoke; and
identify a vocal performance of an audience member that is associated the mobile computing device from the overall vocal performance of the audience,
isolate the vocal performance of the audience member from the overall vocal performance of the audience, and
evaluate the vocal performance of the audience member to score a participation of the audience member in the massive multi-player karaoke.

16. The mobile computing device of claim 15, wherein the at least one mobile computing device is configured to capture the overall vocal performance of the audience as the audience performs the song as part of the massive multi-player karaoke.

17. The mobile computing device of claim 15, wherein the at least one mobile computing device is configured to analyze the overall vocal performance of the audience in a frequency domain for a frequency pattern that is associated with the audience member or in a time domain for a time pattern that is associated with the audience member to identify the vocal performance of the audience member from the overall vocal performance of the audience.

18. The mobile computing device of claim 10, wherein the at least one mobile computing device is configured to identify the frequency pattern or the time pattern from the overall vocal performance of the audience through feature analysis.

19. The mobile computing device of claim 18, wherein the at least one mobile computing device is configured to use Machine Learning (ML), Artificial Intelligence (AI), Neural Networks, Deep Learning (DL), Reinforcement Learning (RL), or Speech Recognition to perform the feature analysis to identify the frequency pattern or the time pattern.

20. The mobile computing device of claim 19, wherein the at least one mobile computing device is configured to train the ML, the AI, the Neural Networks, the DL, the RL, or the Speech Recognition in accordance with training data that is associated with the member of the audience to learn the frequency pattern or the time pattern.
